(19) United States
(12) Patent Application Publication
(10) Pub. No.: US 2007/0032911 A1
(43) Pub. Date: Feb. 8, 2007

(54) Method and system for forecasting an amount of energy needed by an, in particular, industrial consumer from an energy supplier or energy vendor, and device for forecasting energy demand and its use for forecasting

(76) Inventors: Frank-Dieter Clesle, Ravensburg (DE); Gerhard Saller, Siegen (DE)

Correspondence Address: WILLIAM COLLARD;COLLARD & ROE, P.C., 1077 NORTHERN BOULEVARD, ROSLYN, NY, 11576, US

(21) Appl. No.: 11/495,924

(22) Filed: Jul. 28, 2006

(30) Foreign Application Priority Data
Jul. 29, 2005 (EP) 05 016 537.2

(51) Int. Cl. H02J 13/00

(52) U.S. Cl. 700/291

(57) ABSTRACT

The invention relates to a method, its use for forecasting the amount of energy needed by an, in particular, industrial consumer from an energy supplier or vendor, and to a corresponding system and a device for applying the method. The core concept of the invention is a forecasting method which comprises the following method steps: a. creating an initial data series from controlled variables of a future production process in a defined period at at least one consumer; b. determining at least one historical production process in the form of a target data series by comparing the initial data series created with data series from controlled variables of historical production processes; c. determining the historical energy load pattern corresponding to the historical production process determined; d. creating a forecasting plan by means of the historical energy load pattern determined.

### CROSS-REFERENCES TO RELATED APPLICATIONS

This application claims convention priority from European patent application EP 05 016 537.2 filed on Jul. 29, 2005.

### BACKGROUND OF THE INVENTION

1. Field of Invention

The invention relates to a method and its use for forecasting the amounts of energy needed by an, in particular, industrial consumer from an energy supplier or an energy vendor, and a corresponding forecasting system. In addition, the invention relates to a device by means of which the method according to the invention can be used for forecasting the energy needed.

2. Definitions

The term “energy” can be understood to be any type of thermal, mechanical or physical energy, for example electrical power or gas.

“Energy supplier” hereinafter designates a company which generates energy and delivers this energy to at least one consumer either directly via an existing network or delivers the energy provided to an energy vendor.

The term “energy vendor” is understood to mean such companies which operate networks which transport energy and establish a connection between an energy supplier and a consumer. Energy vendors can be, for example, municipal utilities.

A “consumer” in the sense of the present invention can be a natural person, a partnership, a corporate body or any other collectivity of persons which procures energy from an energy supplier or an energy vendor and consumes the energy procured by means of a thermal or physical device.

“Forecasting plan” designates the specification of the amount and of the time of the energy of a consumer needed within a future defined period.

The term “controlled variables” designates data which have a correlation to the energy consumption of an, in particular, industrial production process and the knowledge of which provides adequate knowledge about the characteristic of the amounts of energy needed. This includes, for example, but not exclusively:
physical parameters of the production plant(s) used,
process parameters of the production plant(s) used,
material characteristics,
production planning data,
operating diary which documents the utilization of the plants or machines of a consumer used within defined time intervals,
measurement and meter data of the production plant(s) or
energy costs.

“Energy load pattern” hereinafter designates the energy consumption, shown in a diagram, of an, in particular, industrial consumer over a defined time interval of a production process.

“Production planning data” designates a collective term for data of production-related states or processes of an, in particular, industrial company. This includes, for example, but not exclusively:
order-related data such as, e.g., production times, quantities, qualities,
machine-related data such as operating times, interruption times, manufactured quantities of a machine, messages and disturbances, operator interventions, consumption of material, energy and resources,
material-related data such as, e.g., supply and removal of materials.

The adjective “historical” designates past processes, measurement quantities found and data series determined for an, in particular, industrial consumer.

“Deviation tolerance” designates the permissible difference between the actual values of the controlled variables of historical production processes to be determined and the required nominal values of the controlled variables of a future production process.

3. DESCRIPTION OF THE ART

Due to the liberalization of the energy market, especially in Europe, it is no longer mandatory for a consumer to procure energy, for example in the form of electrical power or gas, and the transportation of this energy from a single provider. The consumer can now choose freely between energy supplier and energy vendor. Significant criteria for this selection are the amount of energy which can be supplied, the time within which this energy can be provided and the costs for providing this energy.

In the liberalized and deregulated energy market, the services of energy generation, energy transport and of the sale of energy to the consumers are performed by different companies. The energy vendor coming into business contact with the consumer procures the amounts of energy needed from the energy generators. In addition, there are possibilities for procuring amounts of energy from so-called energy exchanges. The energy exchanges virtually provide amounts of energy which exist in excess at the energy suppliers or vendors. In Germany and also in most European countries, commercial and, in particular, industrial consumers conclude long-term contracts with their energy vendors which, in most cases, run for at least one year. The contracts existing between the consumers and energy vendors are designed as “complete supply contracts”. This means that the energy vendor owes the provision of the amounts of energy actually needed by the consumer. Since the energy consumption fluctuates greatly, especially in the case of industrial customers, in dependence on the production processes, the type of production and the orders situation, it may happen that the amounts of energy provided exceed or fall below the actual demand of the consumers. Since the energy vendor is contractually obliged for complete supply, he has to correct the over and under capacities in energy with respect to the consumer. This means that he must purchase additionally required amounts of energy from the energy suppliers or energy exchanges—mostly at higher prices—or deliver over capacities to energy exchanges—mostly under worse conditions. The fluctuations to be expected in the consumption of energy needed (also called “forecasting plan risk” in the text which follows) by a company is estimated and priced by the energy vendor on the basis of the preceding year. The energy vendor thus passes the economic forecasting plan risk on to the consumers by means of higher energy prices. For economic calculation and minimizing the cost risks, it is thus essential for the energy vendor to be able to predict the amounts of energy needed by the consumers as accurately as possible. The better the amounts of energy needed by the consumer can be forecast (also called forecasting plan in the text which follows), the lower the economic risk for the energy vendor. The resultant price advantages are passed on to the consumers in the form of more advantageous energy costs by the energy vendor.

Energy forecasts are currently made in the most varied form, predominantly by the energy suppliers, especially for domestic or private customers. For this circle of customers, a sufficiently accurate forecast can be created in a simple manner by way of the so-called “reference day method” by the historically available daily sequence and other data, for example a current weather forecast (for example the consumption on a sunny day in summer). The multiplicity of households in a supply region creates a statistical averaging effect which enables a sufficiently accurate forecast of the amount of energy needed to be made at least for private households. Such a forecast is not adequate for the, in particular, industrial customers since a statistical mean is lacking here due to the different production processes and types of production. If, for example, the working times shift during a production at a customer, considerable deviations already occur which can lead to the energy supplier no longer providing sufficient energy. Due to these fluctuations, dependent on external criteria, the determination of a statistical mean for a number of industrial consumers is not practicable and not sufficiently informative for predicting the actual power demand needed.

From US 2003/0041017 A1, a management system and a method is known which provides by way of interaction between an energy vendor and a multiplicity of consumers that the consumer or consumers inform the energy vendor about the amount of energy needed in the form of energy load profiles. These energy load profiles are collected by the energy vendor. The energy vendor then informs the consumer(s) about a selection of special daily offers for procuring energy. The consumer or consumers make an advantageous selection from these daily offers in accordance with particular criteria. The energy vendor is informed of the selection by the consumers. On the basis of the decisions by the consumers about the daily offers, the energy vendor requests either additional energy, offers superfluous energy to energy exchanges and/or offers special discounts to preferred customers. Said prior art discloses that the historical energy consumption of the machines used within a production process and data about the planned production (production profiles) are used for determining the energy load profile needed. The production profiles used are composed of information about orders, machine time and workforce resources and the storeroom stock.

From US 2003/0041016 A1, a method and a system for the regulated energy market is known which provide that the energy consumer and the energy vendor jointly create energy consumption profiles which are provided to the energy vendor.

The disadvantage of this prior art is that it is not taught how informative forecasts about the future energy demand, which are as accurate as possible, can be obtained by using the production profiles and the historical energy consumption of a consumer.

Finally, a method for forecasting the amounts of energy needed by an industrial consumer is known from the prior art which calculates the energy consumption of a planned production process on the basis of a mathematical description of the process of a unit or of a machine. In addition, the physical parameters of the processing material (e.g. dimension and temperature of a steel slab in rolling) are included in the calculation. This method is very elaborate since a specific model must be formed for each plant. As a result, the method becomes time- and cost-intensive.

### SUMMARY OF INVENTION

Accordingly, it is the object of the invention to forecast the future amount of energy needed by an, in particular, industrial consumer in a simple manner and/or to avoid at least one disadvantage of said prior art.

To achieve the object, a method for forecasting the amount of energy needed by an, in particular, industrial consumer from an energy supplier or an energy vendor is proposed which comprises the following method steps:
a. creating an initial data series from controlled variables of a future production process in a defined period at at least one consumer;
b. determining at least one historical production process in the form of a target data series by comparing the initial data series created with data series from controlled variables of historical production processes;
c. determining the historical energy load pattern corresponding to the historical production process determined;
d. creating a forecasting plan by means of the historical energy load pattern determined;
e. conveying the forecasting plan created to an energy supplier or vendor by listing the amount of energy in dependency of time.

The concept according to the invention consists in that, in the case of production plants of commercial, particularly industrial consumers, the energy load pattern for the energy consumption typically behaves in equivalent manner to the production process and the energy load patterns thus repeat themselves given the same initial situation (production profile). Reliable forecasts about the future energy load patterns can be made by determining historical energy load patterns which are identical or almost identical with the planned production processes due to their controlled variables. This applies, in particular, to consumers with a repetitive consumption characteristic which depends on factors of the production process (such as, e.g., shifts, types of product, tool changing times, orders situation, etc.). The method according to the invention can be applied by itself or preferably by a supplemented known forecasting method.

Furthermore, a system for forecasting the energy needed by an, in particular, industrial consumer from an energy supplier or an energy vendor is proposed.

Furthermore, a device suitable for carrying out the method according to the invention is proposed which preferably uses a data processing system.

Finally, it is proposed to use the method according to the invention for forecasting the future amounts of energy needed by an, in particular, industrial consumer from an energy supplier or an energy vendor.

In particular, the advantages achieved by means of the invention consist in that a selective forecast of the amounts of energy needed can be performed in a technically and technologically simple manner even for those consumers whose energy consumption cannot be determined by statistical means due to greatly fluctuating amounts to be procured.

A further advantage consists in that a consumer-specific energy load pattern is created without having to calculate complicated and elaborate mathematical models of the industrial plants used or machines of a production process.

It is found to be advantageous that, due to the historical production processes determined for the consumer, not only the effective amount of energy needed can be read off but also the time when a particular amount of energy is needed within a production process. If this information is reported to the energy supplier or energy vendor, they can selectively provide the amount of energy needed at a particular time—or a slightly greater amount. Over or under capacities are thus avoided.

A further advantage consists in that the energy forecast is based on controlled variables which are variable. By means of the energy forecast determined, energy schedules are then created which form the basis for the future energy procurement. Changing the energy schedule thus has a direct influence on the amount and time of energy procurement. To improve the energy schedule, e.g. in the form of cost reduction by adapting the energy procurement times to low-price tariffs (for example at particular times of the day or night), the controlled variables of the future production process can be changed. Energy, and thus costs, can be saved by directly changing the production processes. Such energy saving measures can be quantified directly with the aid of the method according to the invention since the changed controlled variables are again used as the basis for the initial data series of the forecasting method and lead to a new energy schedule. This new energy schedule can be used for analyzing and controlling the future production process.

Finally, the consumer, due to the forecasting system according to the invention and the knowledge of the amounts of energy needed for a defined period, has the possibility of purchasing additional energy on the so-called spot market or at energy exchanges, or to provide excessive or self-produced energy (e.g. by means of a gas turbine) to third parties via energy exchanges.

### BRIEF DESCRIPTIONS OF THE DRAWING

The present invention will become more fully understood from the detailed description given herein below and the accompanying drawings which are given by the way of illustration only, and thus are not limitative of the present invention and wherein:

FIG. 1 shows a diagrammatical representation of the operation of the method and of the forecasting system;

FIG. 2 shows a system diagram about the sequence of the energy forecasting method, subdivided into the method steps shown in FIG. 2A to 2F;

FIG. 3 shows a functional diagram of a device for energy forecasting.

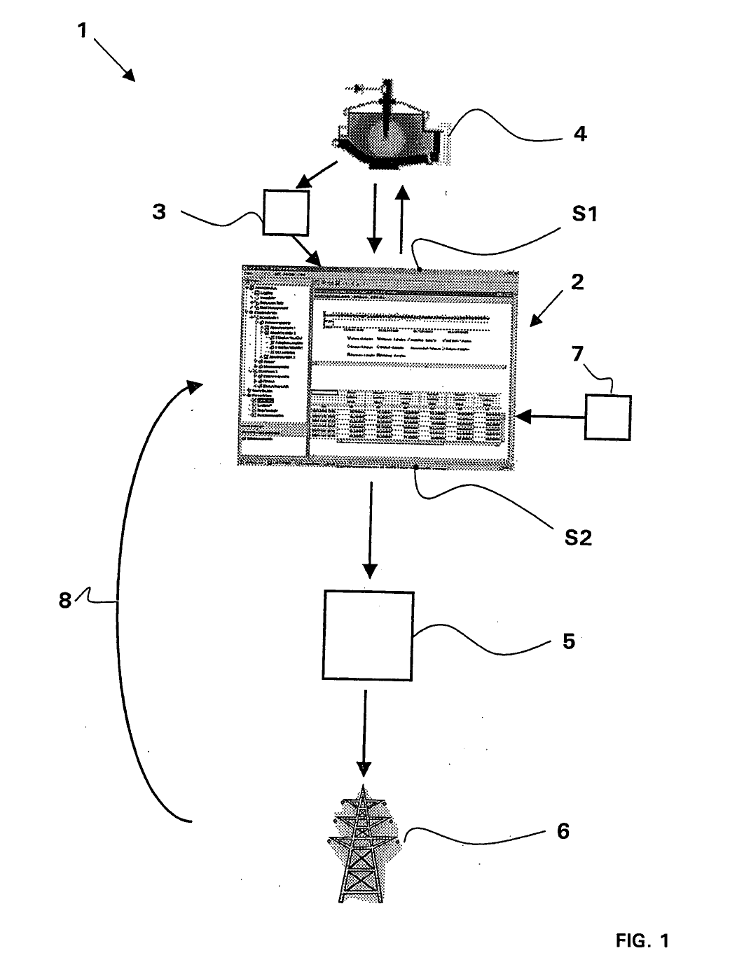

The system 1 shown in FIG. 1 consists of a data processing device 2 which, in turn, comprises interfaces S1 and S2. The first interface S1 is provided for receiving controlled variables 3 for production (a DC electric furnace 4 in the example). Such controlled variables 3 can be, for example, information about orders (type of products, quantities, delivery dates, etc.), data from operating diaries, physical parameters of the production plant(s) used, material properties, production profiles from PPS systems or measurement and meter data of the production plant(s). Reference source for these controlled variables 3 can also be test points on the production plant(s). On this basis, the data processing device 2 determines the amount of energy needed for the future production process and creates a forecasting plan 5. This is output via the interface S2 and conveyed to an energy supplier or vendor 6. The amount of energy 8 actually supplied is documented and compared with the forecasting plan 5 created in order to check and continuously optimize the method according to the invention.

Optionally, cost information 7, by means of which the future energy costs arising can be forecast together with the future amount of energy needed, can be additionally procured for the user of the data processing device 2 during the calculation of the amount of energy needed. This provides the consumer with the capability of performing a simulation of his energy consumption in order to optimize the energy costs, for example by procuring the energy from other providers.

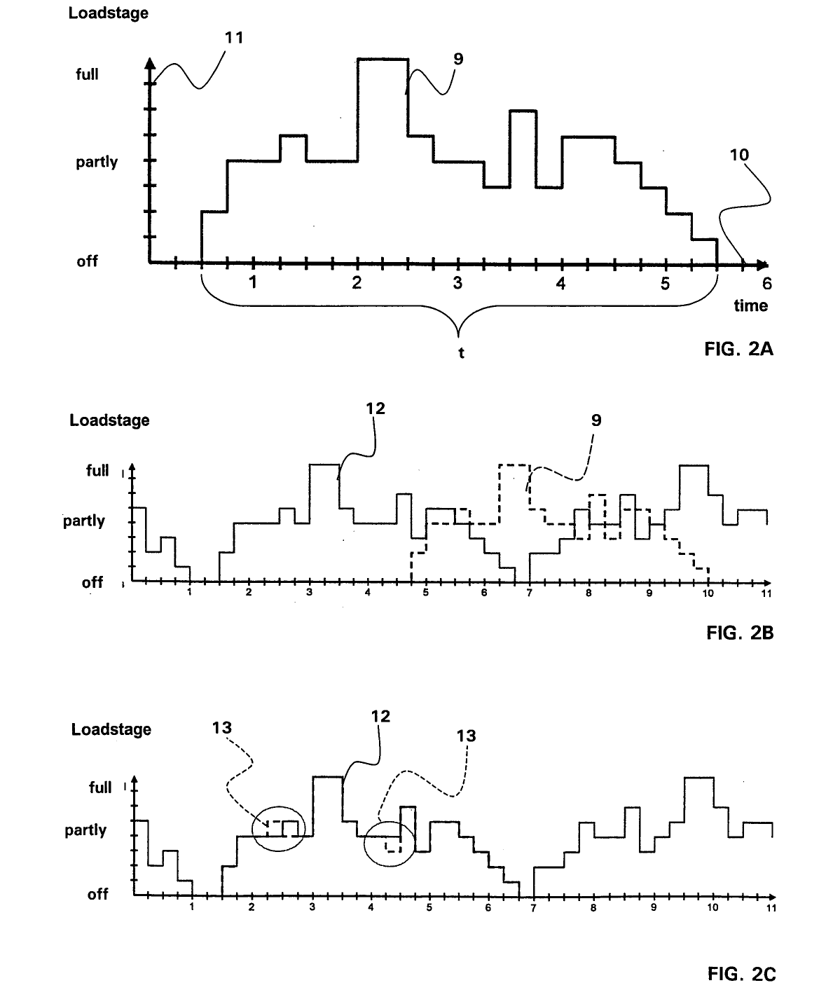

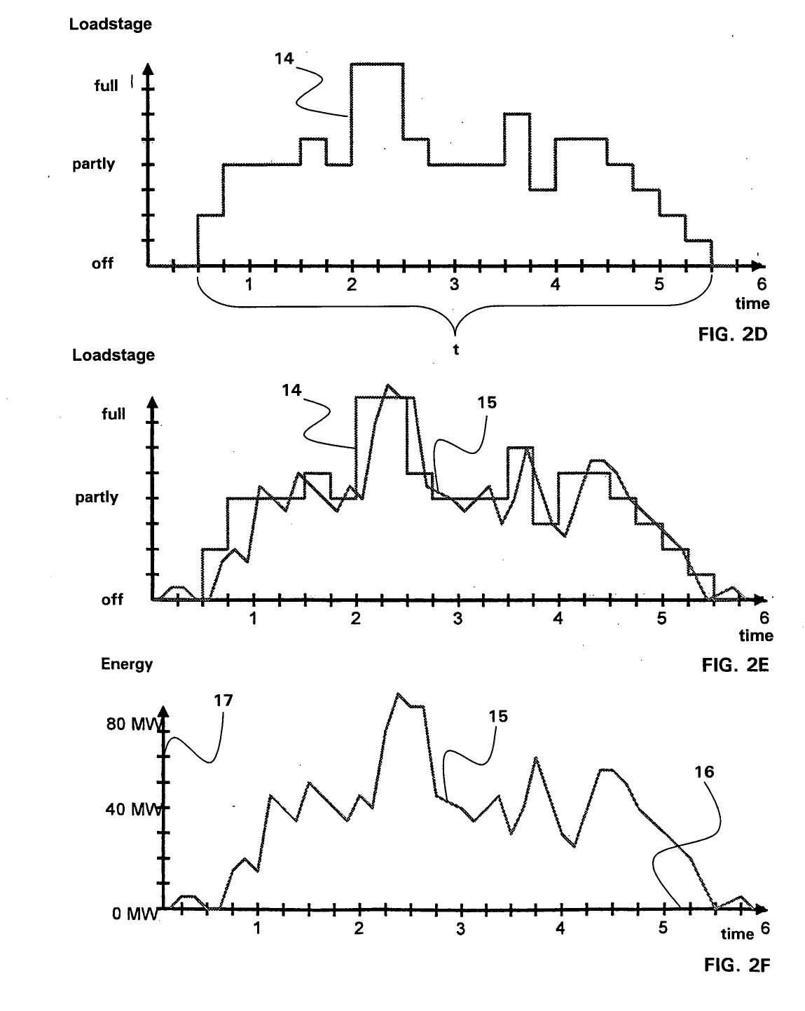

The forecasting process running in the data processing device 2 is shown diagrammatically in FIG. 2A to 2F. Firstly, the controlled variables 3 of the future production process are acquired (not shown). Then an initial data series 9 is created for a defined period t by means of the control variables 3. FIG. 2A shows an exemplary initial data series 9 in the form of a Cartesian system of coordinates. The abscissa 10 specifies the period in hours. The ordinate 11 in the example shows the load stage of an industrial plant subdivided into full and part load and zero load. In the next method step shown in FIG. 2B, a target data series 14 (as shown in FIG. 2D), which approaches the initial data series 9 created as closely as possible, is sought in the stored data series of historical production processes 12.

FIG. 2 shows an advantageous embodiment of the next method step. In this case, an identical historical target data series 14 (as shown in FIG. 2D) is first sought. It is only when such a one cannot be determined that the search (correlation) is continued in an iterative procedure, where the historical target data series must now lie within a previously defined deviation tolerance 13. During this procedure, the deviation tolerance range 13 is increased step by step up to a previously defined maximum range until a target data series 14 (as shown in FIG. 2D) is found which exhibits the least possible deviation from the initial data series 9.

The time interval t, determined in this manner and shown in FIG. 2D, of the historical data series 12 which represents the target data series 14 represents an historical production process. In the next method step, the real actual energy consumption produced in this time interval is extracted in the form of an historical energy load pattern 15 in FIG. 2E. In the exemplary embodiment, the historical energy load pattern 15 reproduced in FIG. 2F shows the variation with time in hours on the abscissa 16 and the amount of energy consumed, in megawatts in the example, on the ordinate 17 in a Cartesian system of coordinates. Finally, the historical energy load pattern 15 is used as a basis for creating a forecasting plan 5 about the energy consumption of the future production process as forecast and transmitted to the energy supplier or vendor 6 (not shown).

Since a number of target data series 14 of historical production processes, all of which correspond to the deviation tolerance 1 3 set, may be determined by means of the method described above, various initial data series 9 are determined from different types of controlled variables 3 for determining an historical production process and at least one historical data series 1 2 is determined for each initial data series 9 within the period t defined, in an advantageous embodiment of the method according to the invention. In this advantageous embodiment, all target data series 14 determined are then delivered to a further data processing device 22 which, in turn, determines via an adjustable deviation tolerance the target data series 14 which has the least deviation from the initial data series 9.

In a further advantageous embodiment of the method according to the invention, the forecasting data obtained can be combined with data from other forecasting methods in order to optimize the energy forecast by way of data alignment. Thus, for example, known forecasting methods such as the determining by means of method models, by means of reference day methods or by manual data input can be used depending on availability and plausibility. The plausibility of the method applied in each case can be determined, for example, by comparing the nominal amount of energy forecast with the actual amount of energy actually procured.

Thus, for example, a check can be made to see whether, according to the forecasting method used, the supply capacity contractually agreed with the energy supplier or vendor is exceeded or underutilized by a definable manipulated variable (e.g. a defined percentage), the previous maximum load is exceeded by a certain percentage, the previous minimum load is underutilized by a certain percentage in production, or whether generally the previous load would be underutilized without production (zero load). In addition, it could be considered for a plausibility check whether a forecast can be created at all on the basis of the available data (e.g. controlled variable 3 or production data).

The greater the deviations between the initial data series 9 (=actual values) and the target data series 14 determined (=nominal values), the more imprecise the forecasting of the future amounts of energy needed. To determine the forecast value of an historical data series determined, i.e. the probability of an applicable statement about the amounts of energy needed, each target data series 14 is marked—in a further advantageous embodiment—with a value which expresses the deviation of the nominal value from the actual value in percentages. Before carrying out the method according to the invention, the consumer can then set that only target data series 14 reaching a minimum percentage are output. With increasing volume of historical data stored, the deviation tolerance can be reduced by increasing the percentage to be achieved. The energy forecasting system is thus self-adapting.

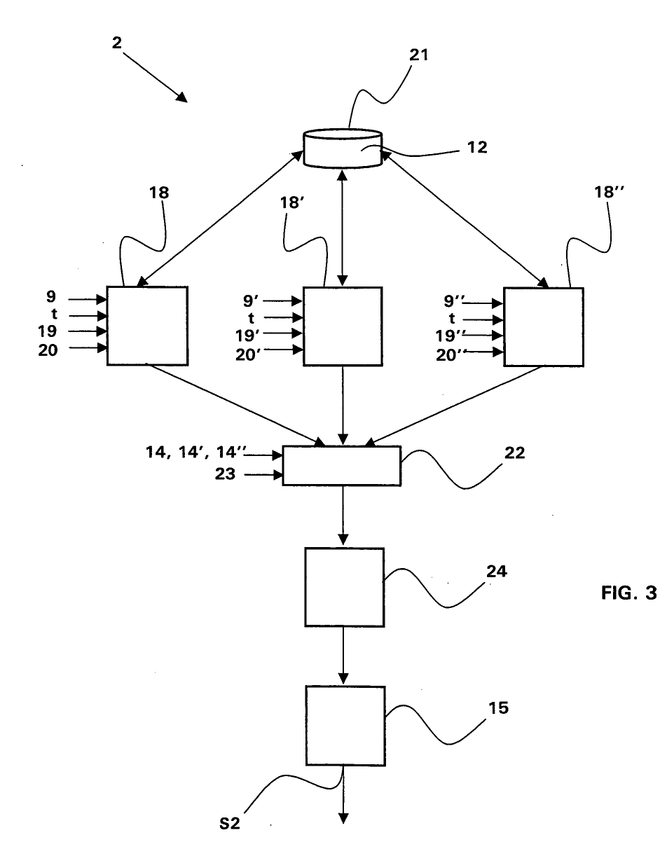

FIG. 3 shows an advantageous exemplary embodiment of the data processing device 2 for carrying out the method according to the invention. The initial data series 9 created and a defined time interval t are input into a processor chip 18 and marked by a corresponding identification variable 19 in accordance with the type of controlled variable used as a basis. In addition, a deviation tolerance 20 can be defined. The processor chip 18 looks in a database 21 in historical data series 12 having corresponding identification variables 19 for a time interval t which is within the defined deviation tolerance 20 and has the least deviation from the initial data series 9.

To optimize the forecasting result, at least one further initial data series 9′, 9″ for the same time interval t is provided with an identification variable 19′, 19″ and read into a further processor chip 18′, 18″ in the advantageous exemplary embodiment shown in FIG. 3. The respective processor chip 18′, 18″ then again looks in the database 21 for an historical data series 12 under the corresponding identification variable 19′, 19″ which represents the least possible deviation from the initial data series 9′ or 9″, respectively, within the deviation tolerance 20′, 20″ set. The historical production processes 14, 14′, 14″ now determined in the processor chips 18, 18′, 18″ are read into a correlation processor 22 which determines the target data series 24 which approaches an adjustable deviation tolerance 23 closest. For the optimized target data series 24 thus determined, the historical energy load pattern 15 produced for this time interval t is extracted which is output as forecasting result via the interface S2.

### LIST OF REFERENCE DESIGNATIONS

1 Energy forecasting system
2 Data processing device
3 Controlled variable
4 DC electric furnace
5 Forecasting plan
6 Energy supplier or vendor
7 Cost listing/information
8 Amount of energy
9 Initial data series
10 Abscissa
11 Ordinate
12 Historical production process
13 Deviation tolerance
14 Target data series
15 Historical energy load pattern
16 Abscissa
17 Processor chip ordinate
18 Identification variable
19 Deviation tolerance
20 Database
21 Correlation processor
22 Deviation tolerance
22 Target data series

What is claimed is:

1. A method for forecasting the amount of energy needed by an, in particular, industrial consumer from an energy supplier or an energy vendor, comprising the following method steps:
a. creating an initial data series from controlled variables of a future production process in a defined period (t) at at least one consumer;
b. determining at least one historical production process in the form of a target data series by comparing the initial data series created with data series from controlled variables of historical production processes;
c. determining the historical energy load pattern corresponding to the historical production process determined;
d. creating a forecasting plan by means of the historical energy load pattern determined;
e, conveying the forecasting plan created to an energy supplier or vendor by listing the amount of energy in dependency of time.

2. The method as claimed in claim 1, wherein the target data series to be determined can be located with a definable deviation tolerance range with respect to the initial data series.

3. A method for forecasting the amount of energy needed by an, in particular, industrial consumer from an energy supplier or an energy vendor, comprising the following method steps:
a. creating an initial data series from controlled variables of a future production process in a defined period (t) at at least one consumer;
b. determining at least one historical production process in the form of a target data series by comparing the initial data series created with data series from controlled variables of historical production processes;
c. determining the historical energy load pattern corresponding to the historical production process determined;
d. creating a forecasting plan by means of the historical energy load pattern determined;
e. conveying the forecasting plan created to an energy supplier or vendor by listing the amount of energy in dependency of time and
at least one further initial data series is created from other controlled variables;
at least one further target data series is determined by means of this further initial data series;
all target data series determined are compared with one another as determined by a defined deviation tolerance and
the target data series which has the least deviation from a defined ideal data series is determined.

4. The method as claimed in claim 1, wherein at least one of the following method steps is optionally carried out with processor support:
a. creating the initial data series,
b. determining the target data series,
c. creating the forecasting plan,
d. conveying the forecasting plan.

5. The method as claimed in claim 1, wherein the amount of energy delivered by the energy supplier or energy vendor is stored in a data processing device.

6. A method for forecasting the amount of energy needed by an, in particular, industrial consumer from an energy supplier or an energy vendor, comprising the following method steps:
a. creating an inital data series from controlled variable of a future production process in a defined period (t) at at least one consumer;
b. determining at least one historical production process in the form of a target data series by comparing the inital data series created with data series from controlled variables of historical production processes;
c. determing the historical energy load pattern corresponding to the historical production process determined;
d. creating a forecasting plan by means of the historical energy load pattern determined;
e. conveying the forecasting plan created to an energy supplier or vendor by listing the amount of energy in dependency of time and
together with the creation of a first forecasting plan by means of the energy load pattern found, at least one further forecasting plan is created by means of a further energy forecasting method, and the consumer makes an advantageous selection according to the criteria of the availability of the amounts of energy determined or of the plausibility of the forecasting plan created from these forecasting plans, the plausibility being determined by comparing the nominal amounts of energy forecast with the actual amounts of energy actually procured.

7. The method as claimed in claim 1, wherein, in conjunction with the creation of the amount of energy forecast, a listing about the costs of the amount of energy needed is also made.

8. The method as claimed in claim 7, wherein the forecasting plan is optimized with respect to energy costs, time of energy request or delivery or the amount of energy procured.

9. The method as claimed in claim 7, wherein the amount of energy needed is optimized with respect to production planning or with respect to the method for producing the products.

10. The method as claimed in claim 1, wherein a number of consumers are combined to form one group for creating the forecasting plan.

11. A system for forecasting the amounts of energy needed by an, in particular, industrial consumer from an energy supplier or in enerby vendor, comprising the following method steps:
a. creating an initial data series from controlled variables of a future production process in a defined period (t) at at least one consumer;
b. determing at least one historical production process in the form of a target data series by comparing the initial data series created with data series from controlled variable of historical production processes;
c. determining the historical energy load pattern corresponding to the historical production process determined;
d. creating a forecasting plan by means of the historial energy load pattern determined;
conveying the forecasting plan created to an energy supplier or vendor by listing the amount of energy in dependency of time.

12. A device for forecasting an amount of energy needed by an, in particular, industrial consumer from an energy supplier or an energy vendor, particularly for carrying out the method, comprising following steps:
a. creating an initial data series from controlled variables of a future production process in a defined period (t) at at least one consumer;
b. determining at least one historical production process in the form of a target data series by comparing the initial data series created with data series from controlled variables of historical production processes;
c. determining the historical energy load pattern corresponding to the historical production process determined;
d. creating a forecasting plan by means of the historical energy load pattern determined;
e. conveying the forecasting plan created by an energy supplier or vendor by listing the amount of energy in dependency of time. wherein
a database with data series consisting of controlled variables of historical production processes
a processor chip for aligning historical data series with at least one initial data series consisting of controlled variables of a future production process.

13. The device as claimed in claim 12, comprising at least one further processor chip and a correlation processor.

14. The use of a method consisting of the following method steps:
a. creating an initial data series from controlled variables of a future production process in a defined period at at least one consumer;
b. determining at least one historical production process in the form of a target data series by comparing the initial data series created with data series from controlled variables of historical production processes;
c. determining the historical energy load pattern corresponding to the historical production process determined;
d. creating a forecasting plan by means of the historical energy load pattern determined;
e. conveying the forecasting plan created to an energy supplier or vendor by listing the amount of energy in dependency of time;
for forecasting the amounts of energy needed by an, in particular, industrial consumer from an energy supplier or an energy vendor.
